(19) United States
(12) Patent Application Publication
(10) Pub. No.: US 2007/0093102 A1
(43) Pub. Date: Apr. 26, 2007

(54) Refrigerator

(75) Inventors: Eun-Seong Park, Jeonju-si (KR); Bu-kil Jeong, Gwangsan-gu (KR); Jin-ho Kim, Buk-gu (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/583,813

(22) Filed: Oct. 20, 2006

(30) Foreign Application Priority Data
Oct. 21, 2005 (KR) 2005-99741

(51) Int. Cl. H01R 3/00

(52) U.S. Cl. 439/164

(57) ABSTRACT

A refrigerator including an outer casing and an inner casing that is spaced from the outer casing across a heat-insulating space, the inner casing forming a storage compartment having a connector-mounting opening, the refrigerator including: a stationary connector provided in the heat-insulating space; a connector fastener accommodating the stationary connector and mounted to the connector-mounting opening; a movable connector coupled to the stationary connector while leaving the connector-mounting opening therebetween; and a connector cover coupled to the connector fastener and accommodating the movable connector and the stationary connector therein. With this configuration, water in a storage compartment is effectively prevented from being introduced into the inside of a connector, thereby preventing a short circuit or malfunction.

### CROSS-REFERENCE TO RELATED APPLICATIONS

This application claims the benefit of Korean Patent Application No. 2005-99741, filed on Oct. 21, 2005, in the Korean Intellectual Property Office, the disclosure of which is incorporated herein by reference.

### BACKGROUND OF THE INVENTION

1. Field of the Invention

The present invention relates to a refrigerator, and more particularly, to a refrigerator having a connector for a cable to supply power to power consumption elements provided in a cool air duct.

2. Description of the Related Art

In general, a refrigerator supplies cool air obtained by a refrigeration cycle to a storage compartment and maintains perishable materials fresh for a long time in the storage compartment.

As shown in FIGS. 1 and 2, a conventional refrigerator 100 includes a main body 110 formed with a storage compartment 111; an evaporator 120 including a refrigerant pipe 121, a refrigerant pipe supporter 122 and a cooling fan 123 to generate the cool air; various power consumption elements; an external power cable (not shown) provided in a heat-insulating space 116; an internal cable 190; and a stationary connector 140 and a movable connector 160 connected to both the external power cable and the internal cable 190, respectively, and connected with each other.

The main body 110 includes an outer casing 115 forming an outer appearance; an inner casing 112 facing the outer casing 115 while leaving the heat-insulating space 116 therebetween, forming the storage compartment and having a connector-mounting opening 113 on one surface thereof; and a foaming heat-insulating material 117 filled in the heat-insulating space 116.

The stationary connector 140 and the movable connector 160 are used in connecting the external power cable connected from an external power source (not shown) and the internal cable 190 supplying power to the power consumption elements such as a defrosting heater 130 or the like.

The stationary connector 140 is mounted to the connector-mounting opening 113 while its contact part 143 is in contact with the rear surface of the inner casing 112, and thus a body 141 thereof formed with a terminal accommodating groove (not shown) protrudes toward the storage compartment 111.

The movable connector 160 includes a first movable connector 160a connected to a pair of internal cables 190a for the defrosting heater, and second and third movable connectors 160b and 160c connected to the internal cables 190b and 190c supplying the power to other power consumption elements, in which the movable connector 160 is coupled with the stationary connector 140.

The defrosting heater 130 is placed nearby the evaporator 120 and removes frost due to temperature difference from the evaporator 120, thereby preventing cooling efficiency from lowering. Other power consumption elements include various sensors (not shown), a bimetal unit (not shown), a lighting unit (not shown), etc. In such a conventional refrigerator 100, there arises a problem in that water attached on the inner casing 112 of the storage compartment 111 flows into the stationary connector 140 and the movable connector 160 and causes a short circuit, thereby making the refrigerator 100 malfunction.

### SUMMARY OF THE INVENTION

Accordingly, it is an aspect of the present invention to provide a refrigerator which can effectively prevent water in a storage compartment from being introduced into the inside of a connector, thereby preventing a short circuit or malfunction.

Additional aspects and/or advantages of the present invention will be set forth in part in the description which follows and, in part, will be apparent from the description, or may be learned by practice of the present invention.

The foregoing and/or other aspects of the present invention can be achieved by providing a refrigerator including an outer casing and an inner casing that is spaced from the outer casing across a heat-insulating space, the inner casing forming a storage compartment having a connector-mounting opening, the refrigerator including a stationary connector provided in the heat-insulating space; a connector fastener accommodating the stationary connector and mounted to the connector-mounting opening; a movable connector coupled to the stationary connector while leaving the connector-mounting opening therebetween; and a connector cover coupled to the connector fastener and accommodating the movable connector and the stationary connector therein.

According to an aspect of the invention, the connector fastener is oriented to point downward toward a bottom of the storage compartment.

According to an aspect of the invention, the refrigerator further includes a protruding part that protrudes outwards from the inner casing and then slants inward toward a bottom of the storage compartment, wherein the connector-mounting opening is formed on a surface of the protruding part.

According to an aspect of the invention, the connector fastener and the connector cover are detachably coupled with each other.

According to an aspect of the invention, one of the connector fastener and the connector cover is formed with at least one coupling groove, and the other one is formed with a coupling projection to be engaged with the coupling groove.

According to an aspect of the invention, the connector fastener includes a partition wall accommodating the stationary connector and inserted in the connector-mounting opening; and a contact part protruding outwardly from circumference of the partition wall and closely contacting a rear surface of the inner casing.

According to an aspect of the invention, the contact part is provided with adhesive to be adhered to the rear surface of the inner casing.

According to an aspect of the invention, the contact part is inclined at a predetermined angle to a cross-section of the partition wall.

According to an aspect of the invention, one end of the connector cover is accommodated in the connector fastener.

According to an aspect of the invention, the connector cover is formed with a cable through groove on one side thereof, through which a cable passes; and the refrigerator further including a sealing member including an elastic material, wrapping the cable and sealing up the cable through groove.

Another aspect of the present invention can be achieved by providing a refrigerator including an outer casing, an inner casing that is spaced from the outer casing across a heat-insulating space, the inner casing forming a storage compartment and having a connector-mounting opening, a cool air duct guiding cool air to the storage consumption element provided in the cool air duct, the refrigerator including: a stationary connector connected with an external power cable provided in the heat-insulating space; a connector fastener accommodating the stationary connector and mounted to the connector-mounting opening; a movable connector connected to the power consumption element through the internal cable, and coupled to the stationary connector while leaving the connector-mounting opening therebetween; and a connector cover coupled to the connector fastener and accommodating the movable connector and the stationary connector therein.

According to an aspect of the invention, the connector fastener is oriented down toward a bottom of the cool air duct.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 illustrates the inside of a conventional refrigerator;

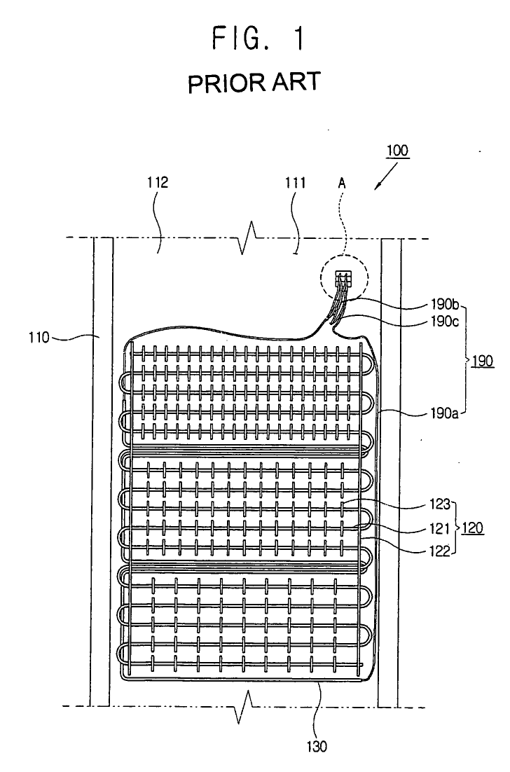

FIG. 2 is an enlarged perspective view of an area ‘A’ in FIG. 1;

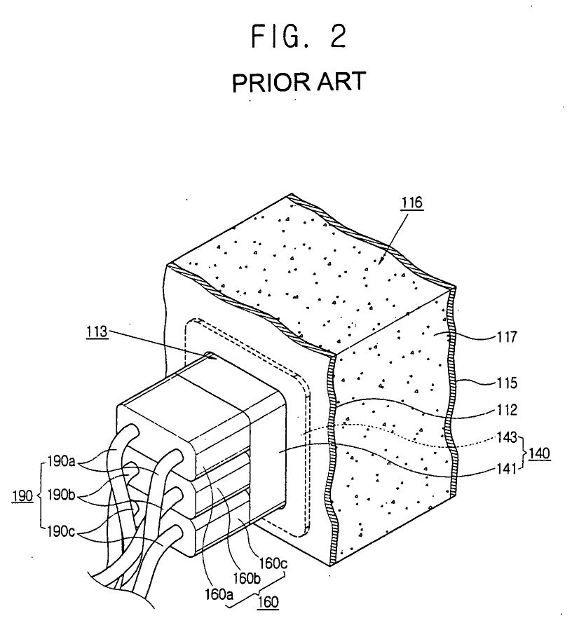

FIG. 3 is a cross-section view of a refrigerator according to a first embodiment of the present invention;

FIG. 4 illustrates the inside of the refrigerator according to the first embodiment of the present invention;

FIG. 5 is an enlarged perspective view of an area ‘B’ in FIG. 4;

FIG. 6 is a cross-section view of the area ‘B’ in the refrigerator according to the first embodiment of the present invention; and

FIG. 7 is an enlarged perspective view of the area ‘B’ in a refrigerator according to a second embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout and repetitive descriptions will be avoided as necessary.

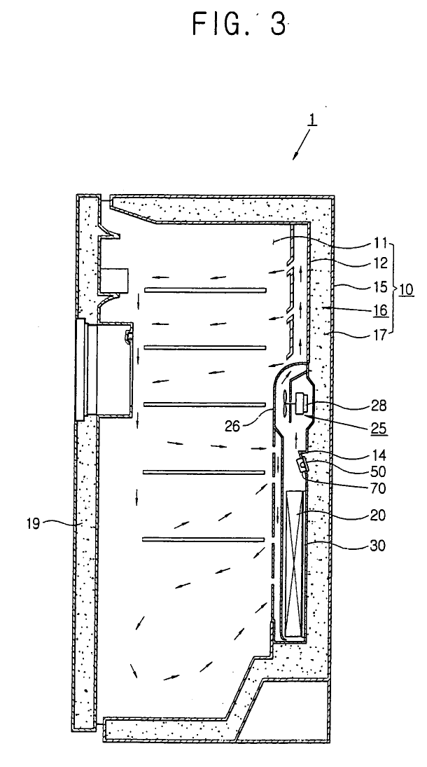

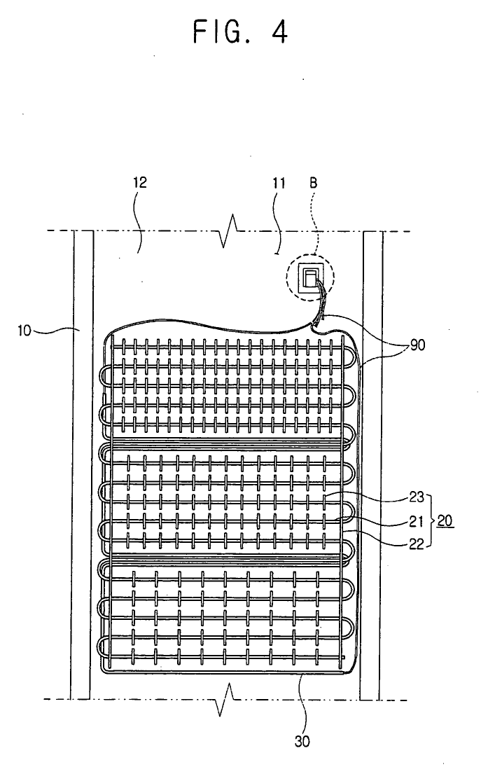

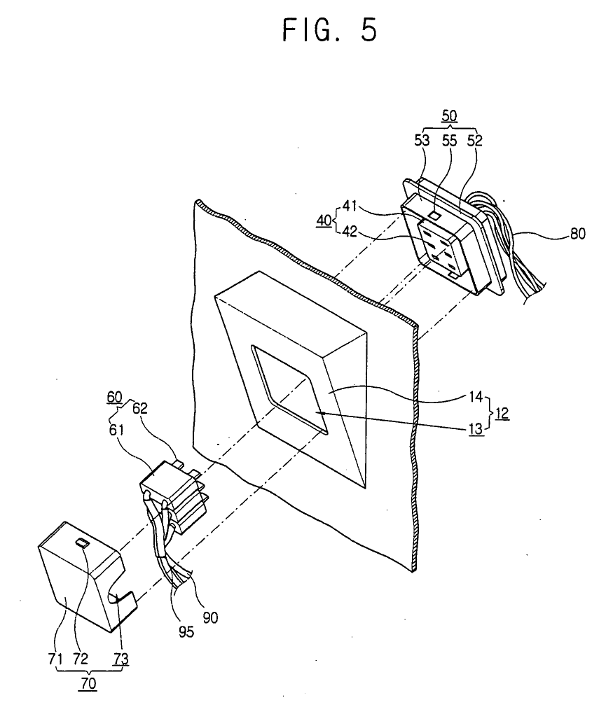

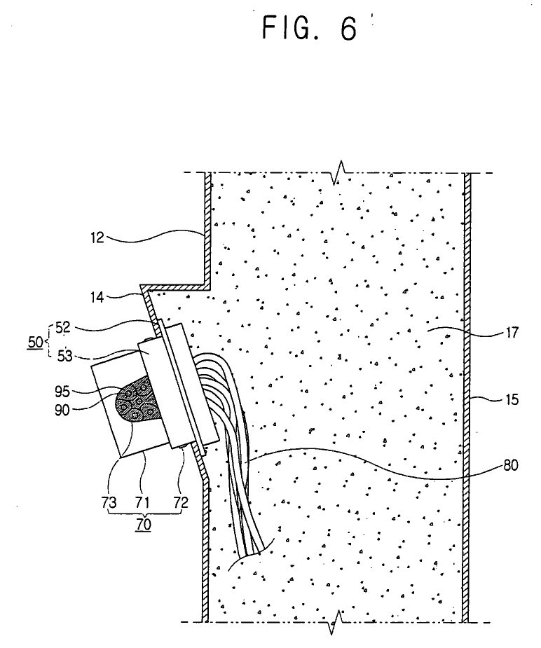

A refrigerator according to a first embodiment of the present invention will be described with reference to FIGS. 3 through 6. FIG. 3 is a cross-section view of a refrigerator according to a first embodiment of the present invention, FIG. 4 illustrates the inside of the refrigerator according to the first embodiment of the present invention, FIG. 5 is an enlarged perspective view of an area ‘B’ in FIG. 4, and FIG. 6 is a cross-section view of the area ‘B’ in the refrigerator according to the first embodiment of the present invention. In FIG. 3, an external cable 80 and an internal cable 90 are not shown.

The refrigerator 1 according to the first embodiment includes a main body 10 formed with a storage compartment 11; a door 19 opening and closing the storage compartment 11; an evaporator 20 generating cool air to be supplied to the storage compartment 11 of the main body 10; a cool air duct 25 introducing the cool air generated by the evaporator 20 into the storage compartment 11; a fan 28 provided inside the cool air duct 25 and blowing the cool air generated by the evaporator 20 toward the storage compartment 11; a defrosting heater 30 provided as one of power consumption elements on an inner casing 12 inside the cool air duct 25; and an external power cable 80 and an internal cable 90.

The main body 10 includes an outer casing 15 forming an outer appearance; the inner casing 12 facing the outer casing 15 while leaving a heat-insulating space 16 therebetween and forming the storage compartment 11; and a foaming heat-insulating material 17 filled in the heat-insulating space 16 between the outer and inner casings 15 and 12.

The storage compartment 111 includes a refrigerator compartment and a freezer compartment.

On the inner casing 12 formed with the cool air duct 25 is formed a connector-mounting opening 13. Here, the inner casing 12 is formed with downward and protruding toward the cool air duct 25. The connector-mounting opening 13 is formed on a front surface of the protruding part 14. The size of the connector-mounting opening 13 may be approximately equal to the cross-section of a connector fastener 50 (to be described later).

The evaporator 20 is provided under the cool air duct 25 of the storage compartment 11, and includes a refrigerant pipe 21 through which a refrigerant passes; a refrigerant pipe supporter 22 supporting the refrigerant pipe 21; and a cooling fin 23 attached to the refrigerant pipe 21.

The cool air duct 25 is a space surrounded with a duct cover 26 and the internal casing 12, and guides the cool air generated by the evaporator 20 to the storage compartment 11. The duct cover 26 forms the cool air duct 25 and hides the elements such as the evaporator 20 in the storage compartment 11 from a user when the door 19 is opened.

As one of the power consumption elements, the defrosting heater 30 is provided between the evaporator 20 and the inner casing 12 in the cool air duct 25, and removes the frost formed around the evaporator 20 by the temperature difference, thereby preventing the cooling efficiency from lowering. Likewise, other power consumption elements such as various sensors (not shown), a bimetal unit (not shown), a lighting unit, etc. are provided inside the cool air duct.

According to this embodiment of the present invention, the refrigerator includes a stationary connector 40 mounted to the connector-mounting opening 13 formed on the inner casing 12, the connector fastener 50, a movable connector 60, and a connector cover 70.

The stationary connector 40 includes a body 41, and a terminal accommodating groove 42 formed on a front surface of the body 41. Meanwhile, the rear of the body 41 is coupled with one side of the external power cable 80 connected to the external power source (not shown).

The connector fastener 50 is made of fire retardants and substantially mounted to the connector-mounting opening 13. Further, the connector fastener 50 includes a partition wall 53 accommodating the stationary connector 40 and inserted in the connector-mounting opening 13, and a contact part 52 protruding outwardly from the circumference of the partition wall 53 so as to closely contact the rear surface of the inner casing 12.

The contact part 52 is in contact with the rear surface of the inner casing 12 around the connector-mounting opening 13, i.e., the rear surface of the protruding part 14. To enhance adhesion between the contact part 52 and the rear surface of the inner casing 12, adhesive or a double-sided adhesive tape is applied to the contact part 52.

The partition wall 53 is formed with a coupling groove 55, so that it can be coupled with a coupling projection 72 of the connector cover 70.

Further, a stationary connector accommodating groove (not shown) is formed in the middle of the connector fastener 50, and thus accommodates the stationary connector 40 such that the body 41 of the stationary connector 40 protrudes from the heat-insulating space 16 toward the cool air duct 25. Here, the stationary connector 40 and the connector fastener 50 are coupled by engaging a coupling groove (not shown) with a coupling projection (not shown) thereof.

The movable connector 60 includes a body 61, and metallic terminals 62 protruding from the body 61 frontward.

The rear of the body 61 is connected with a plurality of inner cables 90 connected from various power consumption elements such as the defrosting heater 30 or the like.

The terminals 62 are connected with the internal cables 90 within the body 61 and coupled to the terminal accommodating grooves 42 of the stationary connector 40, so that the stationary connector 40 and the movable connector 60 are electrically connected with each other, thereby supplying the external power to various power consumption elements such as the defrosting heater 30 or the like.

The connector cover 70 is made of fire retardants. For example, the connector cover 70 can be provided by incombustible metal, fire retardant molding, etc. The connector cover 70 includes a body 71 and a coupling projection 72. Further, a cable through groove 73 is formed on one side of the body 71.

The connector fastener 50 and the connector cover 70 are coupled detachably from each other. In this embodiment, the coupling groove 55 of the connector fastener 50 and the coupling projection 72 of the connector cover 70 are engaged to couple the connector fastener 50 with the connector cover 70. The end of the connector cover 70 may be accommodated inside the partition wall 53 of the connector fastener 50. Thus, water running down from the connector fastener 50 is prevented from being introduced into the cover 70.

In the foregoing description, the coupling groove 55 is formed in the connector fastener 50 and the coupling projection 72 is formed in the connector cover 70, but not limited thereto. Alternatively, the coupling groove may be formed in the connector cover 70, and the coupling projection may be formed in the connector fastener 50.

The cable through groove 73 allows the internal cable 90 coupled to the movable connector 60 to be drawn out even though the connector cover 70 and the connector fastener 50 are coupled with each other such that the stationary connector 40 and the movable connector 60 are shielded from the outside.

The internal cables 90 adjacent to the connector cover 70 are wrapped with sealing members 95 that are elastic and made of fire retardants. The sealing member 95 seals up the cable through groove 73 while contracting at a part to be in contact with the cable through groove 73 when the connector cover 70 is coupled with the connector fastener 50, thereby preventing water from being introduced into the connector fastener 50 and the connector cover 70 which are coupled with each other. Here, the sealing member 95 may be varied. In this embodiment, the sealing member is achieved by a fire retardant sponge by way of example.

Below, a process of assembling the refrigerator according to the embodiment of the present invention will be described with reference to FIGS. 5 and 6.

As described above, the stationary connector 40 is accommodated in a stationary connector accommodating groove (not shown), and thus coupled with the connector fastener 50.

Then, the connector fastener 50 is mounted to the connector-mounting opening 13 in a direction from the rear surface of the inner casing 12 toward the cool air duct 25 before filling the heat-insulating space 16 with the foaming heat-insulating material 17.

Because the connector-mounting opening 13 is formed on the protruding part 14 of the inner casing 12, which is more and more protruded toward the cool air duct 25 as going upward, the partition wall 53 is also oriented down toward the cool air duct 25 when the connector fastener 50 is mounted to the connector-mounting opening 13.

Then, the heat-insulating space 16 is filled with the foaming heat-insulating material 17, and the movable connector 60 is coupled to the stationary connector 40 mounted to the connector-mounting opening 13.

Then, the coupling projection 72 of the connector cover 70 is accommodated in the coupling groove 55 of the connector faster 50, so that the connector fastener 50 and the connector cover 70 are coupled with each other such that the stationary connector 40 and the movable connector 60 are accommodated therein and shielded against the outside.

At this time, the internal cable 90 is accommodated in the cable through groove 73, and the elastic sealing member 95 seals up the cable through groove 73 while contracting at a part thereof to be in contact with the through groove 73, thereby preventing water from being introduced into the connector fastener 50 and the connector cover 70 which are coupled with each other.

In the refrigerator 1 with the foregoing configuration according to the first embodiment of the present invention, the connector fastener 50 and the connector cover 70 are coupled with each other such that the stationary connector 40 and the movable connector 60 are accommodated therein and shielded from the outside, so that water is not introduced and fire owing to a short circuit are prevented. Further, the connector-mounting opening 13 of the inner casing 12 is formed on the protruding part 14 that protrudes more and more toward the cool air duct 25 as going upward, so that the stationary connector 40, the connector fastener 50, the movable connector 60 and the connector cover 70 are also formed to be oriented down toward the cool air duct 25 (refer to FIGS. 5 and 6). Thus, water formed on the tops of the connector fastener 50 and the connector cover 70 can naturally fall by the inclination, thereby more effectively preventing water from being introduced into the storage compartment 11.

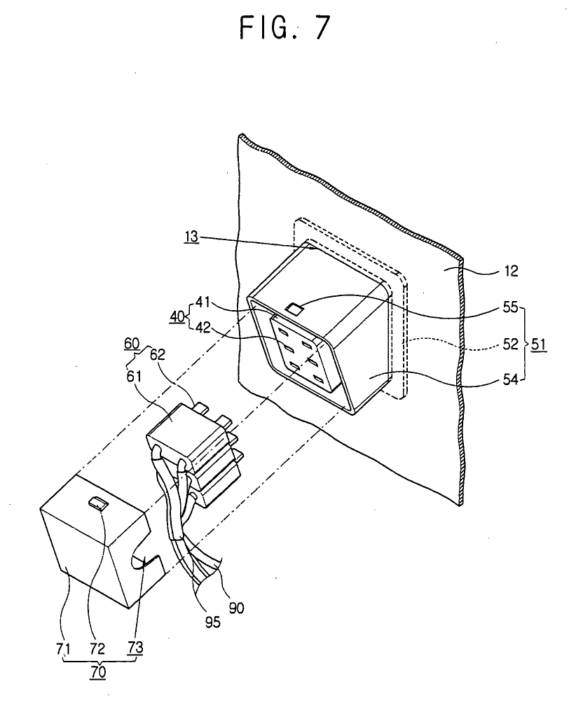

Below, a refrigerator according to a second embodiment of the present invention will be described with reference to FIG. 7, in which repetitive descriptions will be avoided as compared with the first embodiment. FIG. 7 is an enlarged perspective view of the area ‘B’ shown in FIG. 4 in a refrigerator according to a second embodiment of the present invention.

Contrary to the first embodiment, in the refrigerator according to the second embodiment, the partition wall 54 of the connector fastener 51 is formed to be oriented downward instead of orienting the connector-mounting opening 13 formed in the inner casing 12 downward so as to make the stationary connector 40, the connector fastener 50, the movable connector 60 and the connector cover 70 be oriented down toward the cool air duct 25. In other words, the contact part 52 of the connector fastener 51 is inclined at a predetermined angle to the cross-section of the partition wall 54. Thus, the refrigerator according to the second embodiment of the present invention can have the same effect as that of the first embodiment.

The foregoing embodiments may vary. In the above-description, the stationary connector 40 and the connector fastener 50 are separately provided and coupled with each other, but not limited thereto. Alternatively, the stationary connector 40 and the connector fastener 50 may be formed as a single body.

As described above, the present invention provides a refrigerator which can effectively prevent water in a storage compartment from being introduced into the inside of a connector, thereby preventing a short circuit or malfunction.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A refrigerator including an outer casing and an inner casing that is spaced from the outer casing across a heat-insulating space, the inner casing forming a storage compartment having a connector-mounting opening, the refrigerator comprising:
a stationary connector provided in the heat-insulating space;
a connector fastener accommodating the stationary connector and mounted to the connector-mounting opening;
a movable connector coupled to the stationary connector while leaving the connector-mounting opening therebetween; and
a connector cover coupled to the connector fastener and accommodating the movable connector and the stationary connector therein.

2. The refrigerator according to claim 1, wherein the connector fastener is oriented downward toward a bottom of the storage compartment.

3. The refrigerator according to claim 1, further comprising a protruding part that protrudes outwards from the inner casing and then slants inward toward a bottom of the storage compartment,
wherein the connector-mounting opening is formed on a surface of the protruding part.

4. The refrigerator according to claim 1, wherein the connector fastener and the connector cover are detachably coupled with each other.

5. The refrigerator according to claim 4, wherein one of the connector fastener and the connector cover is formed with at least one coupling groove, and the other one is formed with a coupling projection to be engaged with the coupling groove.

6. The refrigerator according to claim 1, wherein the connector fastener comprises:
a partition wall accommodating the stationary connector and inserted in the connector-mounting opening; and
a contact part protruding outwardly from circumference of the partition wall and closely contacting a rear surface of the inner casing.

7. The refrigerator according to claim 6, wherein the contact part is provided with adhesive to be adhered to the rear surface of the inner casing.

8. The refrigerator according to claim 6, wherein the contact part is inclined at a predetermined angle to a cross-section of the partition wall.

9. The refrigerator according to claim 1, wherein one end of the connector cover is accommodated in the connector fastener.

10. The refrigerator according to claim 1, wherein the connector cover is formed with a cable through groove on one side thereof, through which a cable passes; and
the refrigerator further comprising a sealing member including an elastic material, wrapping the cable and sealing up the cable through groove.

11. A refrigerator comprising an outer casing, an inner casing that is spaced from the outer casing across a heat-insulating space, forming a storage compartment having a connector-mounting opening, a cool air duct guiding cool air to the storage compartment, and a power consumption element provided in the cool air duct, the refrigerator comprising:
a stationary connector connected with an external power cable provided in the heat-insulating space;
a connector fastener accommodating the stationary connector and mounted to the connector-mounting opening;
a movable connector connected to the power consumption element through the internal cable, and coupled to the stationary connector while leaving the connector-mounting opening therebetween; and
a connector cover coupled to the connector fastener and accommodating the movable connector and the stationary connector therein.

12. The refrigerator according to claim 11, wherein the connector fastener is oriented down toward the cool air duct.

13. A method of preventing water from entering a movable connector and a stationary connector of a refrigerator having an outer casing and an inner casing that is spaced from the outer casing across a heat-insulating space, the inner casing forming a storage compartment having a connector-mounting opening, the method comprising:
positioning the stationary connector in the heat-insulating space;
fastening the stationary connector to the connector-mounting opening;
coupling the movable connector to the stationary connector while leaving the connector-mounting opening therebetween; and
covering the movable connector.

14. The method according to claim 13, wherein the stationary connector is oriented to point downward toward a bottom of the storage compartment.

15. The method according to claim 13, protruding the connector mounting-opening outwards from the inner casing and slanting the connector mounting opening inward and downward toward a bottom of the storage compartment.
